(19) United States
(12) Patent Application Publication
(10) Pub. No.: US 2025/0172310 A1
(43) Pub. Date: May 29, 2025

(54) AIR CONDITIONER, AIR CONDITIONER SYSTEM, AND CONTROL METHOD THEREOF

(71) Applicant: SAMSUNG ELECTRONICS CO., LTD., Suwon-si (KR)

(72) Inventor: Yunsue JUNG, Suwon-si (KR)

(73) Assignee: SAMSUNG ELECTRONICS CO., LTD., Suwon-si (KR)

(21) Appl. No.: 19/038,092

(22) Filed: Jan. 27, 2025

Related U.S. Application Data
(63) Continuation of application No. PCT/KR2023/010920, filed on Jul. 27, 2023.

(30) Foreign Application Priority Data
Sep. 13, 2022 (KR) 10-2022-0115236

(51) Int. Cl. F24F 11/63

(52) U.S. Cl. CPC F24F 11/63

(57) ABSTRACT

An air conditioning system comprising an air conditioner including a plurality of outdoor units and a plurality of indoor units; and a server configured to generate first location information indicating locations of the plurality of outdoor units based on the unique information of the plurality of outdoor units, the unique information of the plurality of indoor units, and location information of a user terminal during a test operation of the plurality of outdoor units and the plurality of indoor units, and transmit a control command to control the air conditioner using the first location information and second location information that indicates a current location of the user terminal to the air conditioner, based on unique information of the at least one outdoor unit or unique information of at least one indoor unit being input from a user.

### CROSS-REFERENCE TO RELATED APPLICATION

This application is a continuation application is a continuation application, under 35 U.S.C. § 111(a), of international application No PCT/KR2023/010920, filed Jul. 27, 2023, which claims priority under 35 U. S. C. § 119 to Korean Patent Application No. 10-2022-0115236, filed Sep. 13, 2022, the disclosures of which are incorporated herein by reference in their entireties.

### TECHNICAL FIELD

The disclosure relates to an air conditioner, an air conditioning system, and a control method thereof.

### BACKGROUND ART

An air conditioner is an apparatus for conditioning air in an indoor space by using transfer of heat produced from evaporation and condensation of a refrigerant to cool or heat the air and release the cooled or heated air. The air conditioner may circulate the refrigerant through a compressor, an indoor heat exchanger, and an outdoor heat exchanger during a cooling operation or a heating operation, and cool or heat the indoor space by releasing the air that has exchanged heat in the indoor heat exchanger into the indoor space.

In existing air conditioners, one indoor unit is connected to one outdoor unit. Recently, however, there has been an increasing demand for air conditioners that perform heating and cooling for a building with multiple independent spaces, such as schools and companies, by connecting a plurality of indoor units to one outdoor unit.

When the cooling or heating of an indoor unit of an air conditioner is not working properly or an inspection situation occurs, in most cases, an outdoor unit to which the indoor unit is connected requires to be found and checked.

In a case where an outdoor unit connected to a malfunctioning indoor unit requires to be found among a large number of outdoor units, finding the physical location of the outdoor unit to be checked may be time-consuming.

### DISCLOSURE

### Technical Problem

The disclosure provides an air conditioner, an air conditioning system, and a control method thereof that may quickly identify a location of an outdoor unit connected to a malfunctioning indoor unit.

### Technical Solution

According to an embodiment of the disclosure, an air conditioning system may include: an air conditioner including a plurality of outdoor units and a plurality of indoor units communicatively connected to each other; and a server configured to be communicatively connected to the air conditioner, so that while the server is communicatively connected to the air conditioner, the air conditioner may be configured to transmit unique information of the plurality of outdoor units and unique information of the plurality of indoor units to the server. The server may be configured to generate first location information indicating locations of the plurality of outdoor units based on the unique information of the plurality of outdoor units, the unique information of the plurality of indoor units, and location information of a user terminal during a test operation of the plurality of outdoor units and the plurality of indoor units, and transmit a control command to control the air conditioner using the first location information and second location information that indicates a current location of the user terminal to the air conditioner, based on unique information of the at least one outdoor unit among the plurality of outdoor units or unique information of at least one indoor unit among the plurality of indoor units being input from a user.

The server may be configured to determine a distance between the user terminal and the at least one outdoor unit among the plurality of outdoor units based on the first location information and the second location information, and based on the distance between the user terminal and the at least one outdoor unit among the plurality of outdoor units being within a preset distance, transmit, to the air conditioner, a control command for controlling the plurality of indoor units connected to the at least one outdoor unit among the plurality of outdoor units to allow the at least one outdoor unit among the plurality of outdoor units to be turned on and to be turned off after a defined period of time.

The server may be configured to determine a distance between the user terminal and the at least one outdoor unit among the plurality of outdoor units based on the first location information and the second location information, and based on the distance between the user terminal and the at least one outdoor unit among the plurality of outdoor units being within a preset distance, transmit, to the air conditioner, a control command for controlling the plurality of indoor units connected to the at least one outdoor unit among the plurality of outdoor units to allow the at least one outdoor unit among the plurality of outdoor units to be turned on and off periodically.

The server may be configured to determine a distance between the user terminal and the at least one outdoor unit among the plurality of outdoor units based on the first location information and the second location information, and based on the distance between the user terminal and the at least one outdoor unit among the plurality of outdoor units being within a preset distance, transmit, to the air conditioner, a control command to allow all of the plurality of indoor units connected to the at least one outdoor unit among the plurality of outdoor units to be turned on and to be turned off after a defined period of time.

The server may be configured to determine a distance between the user terminal and the at least one outdoor unit among the plurality of outdoor units based on the first location information and the second location information, and based on the distance between the user terminal and the at least one outdoor unit among the plurality of outdoor units being within a preset distance, transmit, to the air conditioner, a control command to allow all of the plurality of indoor units connected to the at least one outdoor unit among the plurality of outdoor units to be turned on and off periodically.

The unique information of the plurality of outdoor units or the unique information of the plurality of indoor units may include at least one of device information of the plurality of outdoor units, serial numbers of the plurality of outdoor units, device information of the plurality of indoor units, serial numbers of the plurality of indoor units, or information input by the user during the test operation.

The server may be configured to control a screen displaying the first location information to be output by the user terminal, based on the unique information of the at least one outdoor unit among the plurality of outdoor units or the unique information of the at least one indoor unit among the plurality of indoor units being input from the user.

According to an embodiment of the disclosure, in a method of controlling an air conditioning system including an air conditioner including a plurality of outdoor units and a plurality of indoor units communicatively connected to the plurality of outdoor units, and a server configured to be communicatively connected to the air conditioner, the method may include: transmitting, by the air conditioner, unique information of the plurality of outdoor units and unique information of the plurality of indoor units to the server; generating, by the server, first location information indicating locations of the plurality of outdoor units based on the unique information of the plurality of outdoor units, the unique information of the plurality of indoor units, and location information of a user terminal during a test operation of the plurality of outdoor units and the plurality of indoor units; and transmitting, by the server, a control command to control the air conditioner using the first location information and second location information that indicates a current location of the user terminal to the air conditioner, based on unique information of at least one outdoor unit among the plurality of outdoor units or unique information of at least one indoor unit among the plurality of indoor units being input from a user.

The transmitting of the control command to the air conditioner may include determining a distance between the user terminal and the at least one outdoor unit among the plurality of outdoor units based on the first location information and the second location information, and based on the distance between the user terminal and the at least one outdoor unit among the plurality of outdoor units being within a preset distance, transmitting, to the air conditioner, a control command for controlling the plurality of indoor units connected to the at least one outdoor unit among the plurality of outdoor units to allow the at least one outdoor unit among the plurality of outdoor units to be turned on and to be turned off after a defined period of time

The transmitting of the control command to the air conditioner may include determining a distance between the user terminal and the at least one outdoor unit among the plurality of outdoor units based on the first location information and the second location information, and based on the distance between the user terminal and the at least one outdoor unit among the plurality of outdoor units being within a preset distance, transmitting, to the air conditioner, a control command for controlling the plurality of indoor units connected to the at least one outdoor unit among the plurality of outdoor units to allow the at least one outdoor unit among the plurality of outdoor units to be turned on and off periodically.

The transmitting of the control command to the air conditioner may include determining a distance between the user terminal and the at least one outdoor unit among the plurality of outdoor units based on the first location information and the second location information, and based on the distance between the user terminal and the at least one outdoor unit among the plurality of outdoor units being within a preset distance, transmitting, to the air conditioner, a control command to allow all of the plurality of indoor units connected to the at least one outdoor unit among the plurality of outdoor units to be turned on and to be turned off after a defined period of time.

The transmitting of the control command to the air conditioner may include determining a distance between the user terminal and the at least one outdoor unit among the plurality of outdoor units based on the first location information and the second location information, and based on the distance between the user terminal and the at least one outdoor unit among the plurality of outdoor units being within a preset distance, transmitting, to the air conditioner, a control command to allow all of the plurality of indoor units connected to the at least one outdoor unit among the plurality of outdoor units to be turned on and off periodically.

The unique information of the plurality of outdoor units or the unique information of the plurality of indoor units may include at least one of device information of the plurality of outdoor units, serial numbers of the plurality of outdoor units, device information of the plurality of indoor units, serial numbers of the plurality of indoor units, or information input by the user during the test operation.

The server may be configured to control a screen displaying the first location information to be output by the user terminal, based on the unique information of the at least one outdoor unit among the plurality of outdoor units or the unique information of the at lease one indoor unit the plurality of indoor units being input from the user.

According to an embodiment of the disclosure, an air conditioner may include: an outdoor unit, a plurality of indoor units configured to be communicatively connected to the outdoor unit, communication circuitry configured to communicate with a server, and a controller configured to control the plurality of outdoor units and the plurality of indoor units, wherein the communication circuitry may be configured to transmit unique information of the plurality of outdoor units and unique information of the plurality of indoor units to the server and receive a control command determined based on first location information indicating a location of the outdoor unit and second location information indicating a current location of a user terminal, and the controller may be configured to control the outdoor unit or the plurality of indoor units based on the control command received from the server.

The controller may be configured to control the plurality of indoor units connected to the outdoor unit to allow the outdoor unit to be turned on and to be turned off after a defined period of time, based on the control command received from the server.

The controller may be configured to control the plurality of indoor units connected to the outdoor unit to allow the outdoor unit to be turned on and off periodically, based on the control command received from the server.

The controller may be configured to turn on all of the plurality of indoor units and turn off all of the plurality of indoor units after a defined period of time, based on the control command received from the server.

The controller may be configured to turn on and off all of the plurality of indoor units periodically, based on the control command received from the server.

### Advantageous Effects

According to an aspect of the disclosure, an air conditioner, an air conditioning system, and a control method thereof that may quickly identify a location of an outdoor unit connected to a malfunctioning indoor unit.

### DESCRIPTION OF DRAWINGS

FIG. 1 is a conceptual diagram of an air conditioning system according to an embodiment of the disclosure.

FIG. 2 is a control block diagram of an air conditioning system according to an embodiment of the disclosure.

FIG. 3 illustrates a signal flow of an air conditioning system according to an embodiment of the disclosure.

FIG. 4 and FIG. 5 are diagrams illustrating an operation of an outdoor unit according to an embodiment of the disclosure.

FIG. 6A and FIG. 6B are diagrams illustrating an operation of an indoor unit according to an embodiment of the disclosure.

FIG. 7 is a view illustrating an operation of an air conditioner according to an embodiment of the disclosure.

FIG. 8 is a flowchart illustrating a case in which a server of an air conditioning system transmits a control command for controlling an air conditioner according to an embodiment of the disclosure.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

The terms used herein are used only to describe particular embodiments and are not intended to limit the disclosure. The singular form of a noun corresponding to an item may include one or more of the items unless clearly indicated otherwise in a related context.

It is to be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

The terms such as “portion”, “device”, “block”, “member”, and “module” indicate a unit for processing at least one function or operation. For example, those terms may refer to at least one process processed by at least one hardware such as field programmable gate array (FPGA), application specific integrated circuit (ASIC), at least one software stored in a memory or a processor.

The terms, such as “first,” “second”, and the like used herein may refer to various elements of various embodiments of the disclosure, but do not limit the elements.

Reference numerals used for method steps are just used for convenience of description, but not to limit an order of the steps. Thus, unless the context clearly dictates otherwise, the written order may be practiced otherwise.

The term “at least one” used herein includes any and all combinations of the associated listed items. For example, it is to be understood that the term “at least one of a, b, or c” may include only a, only b, only c, both a and b, both a and c, both b and c, or all of a, b and c.

Hereinafter, an air conditioner, an air conditioning system, and a control method thereof according to an aspect of the disclosure are described in detail with reference to the accompanying drawings.

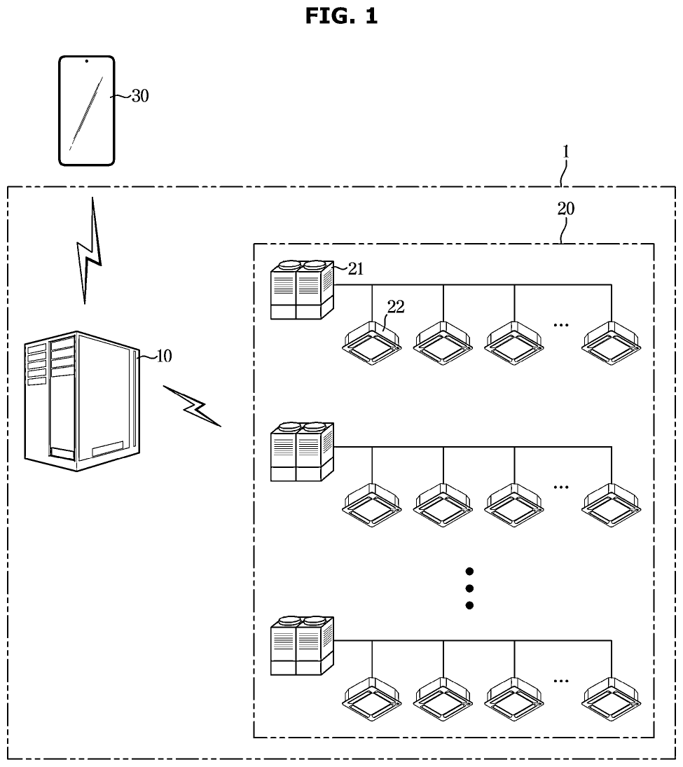

FIG. 1 is a conceptual diagram of an air conditioning system according to an embodiment of the disclosure.

Referring to FIG. 1, an air conditioning system 1 according to an embodiment may include a server 10 transmitting a control command to an air conditioner 20, and the air conditioner 20 including a plurality of outdoor units and a plurality of indoor units that are communicatively connected to the plurality of outdoor units.

The server 10 may communicate with the air conditioner 20 and a user terminal 30 through a wide area network.

Accordingly, the server 10 may control the air conditioner 20 based on information received from the air conditioner 20 and the user terminal 30.

The air conditioner 20 includes an outdoor unit 21 installed outdoors to perform heat exchange between outdoor air and a refrigerant, and an indoor unit 22 installed indoors to perform heat exchange between indoor air and a refrigerant. The outdoor unit 21 may be located outside an air conditioning space, and the indoor unit 22 may be located in the air conditioning space. The air conditioning space refers to a space that is cooled or heated by the air conditioner 20. For example, the outdoor unit 21 may be located outside a building, and the indoor unit 22 may be located in a space separated from the outside by a wall, such as a living room or an office room. In addition, the air conditioner 20 may include a plurality of outdoor units and a plurality of indoor units.

The air conditioner 20 may be connected to a wide area network, and the wide area network may include at least one of a telecommunications network, a computer network (e.g., a local area network (LAN) or a wide area network (WAN)), the Internet, or a telephone network.

Accordingly, the air conditioner 20 may communicate with other electronic devices, such as the server 10 and the user terminal 30.

The user terminal 30 may be implemented as a computer or portable terminal that may connect to the server 10 via a network. Here, the computer may include, for example, a laptop, a desktop, a tablet personal computer (PC), a slate PC, and the like, equipped with a web browser. The portable terminal may include, for example, all kinds of handheld-based wireless communication device that guarantee portability and mobility such as a personal communication system (PCS), a global system for mobile communication (GSM), a personal digital cellular (PDC), a personal handyphone system (PHS), a personal digital assistant (PDA), an international mobile telecommunication (IMT)-2000, a code division multiple access (CDMA)-2000, a wideband CDMA (WCDMA), a wireless broadband Internet (WiBro) terminal, and a smartphone, and wearable devices such as a watch, ring, bracelet, anklet, necklace, eyeglasses, contact lenses, or head-mounted-device (HMD), and the like.

The user terminal 30 may transmit location information to the server 10 according to user input, and to this end, the user terminal 30 may include a wireless communication module corresponding to each communication protocol.

For example, in a case where a user transmits a test operation command to the air conditioner 20 or the server 10 after installation of the air conditioner 20, the user terminal 30 may transmit location information of the user terminal 30 to the server 10 during the test operation.

In addition, in a case where unique information of one outdoor unit of a plurality of outdoor units or unique information of one indoor unit 22 of a plurality of indoor units is input from a user, current location information of the user terminal 30 may be transmitted to the server 10.

The user terminal 30 may receive information from the server 10 and output the received information to the user. For example, in a case where the unique information of one outdoor unit of the plurality of outdoor units or the unique information of one indoor unit 22 of the plurality of indoor units is input from the user and the user terminal 30 transmits the location information of the user terminal 30, the user terminal 30 may receive information indicating location information of the outdoor unit 21 from the server 10 and may output a screen for the location information of the outdoor unit 21.

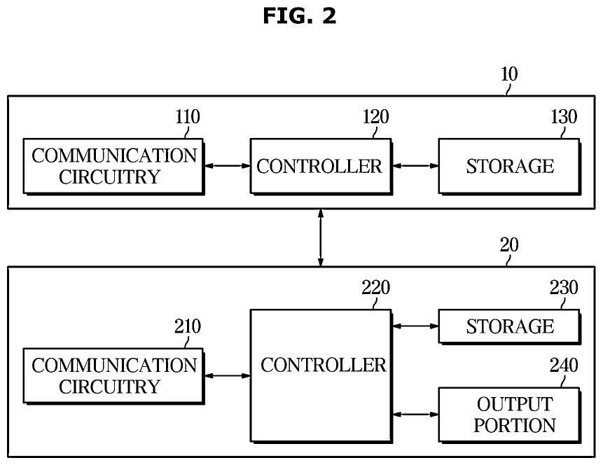

FIG. 2 is a control block diagram of an air conditioning system according to an embodiment of the disclosure.

Referring to FIG. 2, the server 10 according to an embodiment may include communication circuitry 110 communicating with the air conditioner 20 or the user terminal 30, a controller 120 controlling an operation of the server 10, and a storage 130 storing various information required for controlling the server.

The communication circuitry 110 may be connected to a wide area network via wireless communication or wired communication to communicate with the air conditioner 20 or the user terminal 30.

The communication circuitry 110 may receive unique information of a plurality of outdoor units and unique information of a plurality of indoor units of the air conditioner, and may transmit a control command to the air conditioner 20.

The unique information refers to information that may identify one outdoor unit among the plurality of outdoor units. For example, the unique information may be device information of an outdoor unit, a serial number of an outdoor unit, device information of an indoor unit, device information of the plurality of indoor units, or information input by a user during a test operation.

The communication circuitry 110 may receive a user input from the user terminal 30 and location information of the user terminal, and may transmit location information of an outdoor unit according to the user input to the user terminal 30.

The wireless communication and wired communication used by the communication circuitry 110 may correspond to any one of communication protocols used by the air conditioner 20.

The controller 120 may receive the location information of the user terminal during the test operation of the air conditioner and the unique information of the plurality of outdoor units and the unique information of the plurality of indoor units through the communication circuitry 110.

Accordingly, the controller 120 may generate information about the outdoor units connected to each indoor unit using the information about the plurality of outdoor units and the plurality of indoor units, and may generate first location information indicating the respective locations of the plurality of outdoor units.

Specifically, the first location information may be information about a global positioning system (GPS) signal where the user terminal was located during the test operation of the air conditioner 20, information about a beacon signal of Bluetooth module, or information about a wireless fidelity (Wi-Fi) signal.

In a case where at least one of the unique information of one of the plurality of outdoor units, the unique information of one of the plurality of indoor units, or information input by the user during the test operation is input from the user through the communication circuitry 110, the controller 120 may determine the first location information of the outdoor unit corresponding to the user input.

For example, in a case where a serial number of an indoor unit is input by the user, the controller 120 may determine an outdoor unit connected to the indoor unit input by the user and determine the first location information of the outdoor unit.

In addition, the controller 120 may request second location information, which is a current location of the user terminal, to the user terminal 30 through the communication circuitry 110.

The controller 120 may transmit a control command to control the air conditioner 20 using the determined first location information and the second location information to the air conditioner 20.

In addition, when the first location information of the outdoor unit corresponding to the user input is determined, the controller 120 may transmit, to the user terminal 30, a control command to allow the user terminal to output a screen displaying the first location information.

The controller 120 may include at least one memory storing programs for performing the operation described above and the operation to be described below, and at least one processor for executing the stored programs.

The storage 130 according to an embodiment may store the unique information of the outdoor units or the unique information of the indoor units received from the air conditioner.

As such, in order to store various types of information, the storage 130 may be implemented as at least one of non-volatile memories, such as cache, read only memory (ROM), programmable read only memory (PROM), erasable programmable read only memory (EPROM), electrically erasable programmable read only memory (EEPROM), and flash memory, volatile memories, such as random access memory (RAM), or a recording medium, such as a hard disk drive (HDD) or compact disc read only memory (CD-ROM). However, the disclosure is not limited thereto, and any type capable of storing various types of information may be used as the storage 130.

Referring to FIG. 2, the air conditioner 20 may include communication circuitry 210 communicating with the server 10, a controller 220 controlling the operation of the air conditioner, a storage 230 storing various information required for controlling the air conditioner, and an output portion 240 operating according to an operation command.

The communication circuitry 210 may communicate with the server 10 or the user terminal 30. Specifically, the communication circuitry 210 may receive a control command from the server 10 and transmit unique information of outdoor units and unique information of indoor units to the server 10.

To this end, the communication circuitry 210 may be connected to the server 10 or the user terminal 30 using wired communication or wireless communication.

The controller 220 may control the output portion 240 based on the control command received from the server 10.

For example, the controller 220 may periodically turn on and off the indoor unit based on the control command received from the server 10 to allow a fan of the outdoor unit to be operated periodically.

The controller 220 may include at least one memory storing programs for performing the operation described above and the operation to be described below, and at least one processor for executing the stored programs.

The storage 230 may store control information of the output portion according to the control command received from the server 10 through the communication circuitry 210.

As such, in order to store various types of information, the storage 230 may be implemented as at least one of a recording medium such as a cache, ROM, PROM, or CD-ROM. However, the disclosure is not limited thereto, and any type capable of storing various types of information may be used as the storage 230.

The output portion 240 may include an outdoor fan for enabling effective heat exchange between a refrigerant circulating in an outdoor heat exchanger and outdoor air, and an indoor fan for enabling effective heat exchange between the refrigerant and the air around the indoor unit 22.

The output portion 240 may operate according to the control command received from the server 10. For example, the outdoor fan or the indoor fan may be operated according to the control command received from the server 10.

Each component of the air conditioning system has been described in detail above. Hereinafter, operation of the air conditioning system is described in detail.

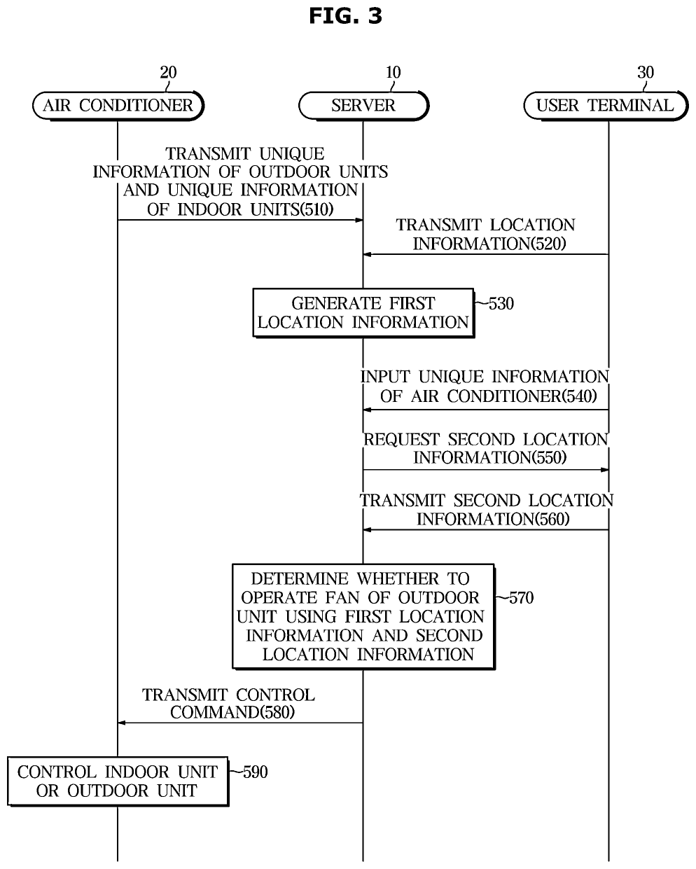

FIG. 3 illustrates a signal flow of an air conditioning system according to an embodiment of the disclosure.

Referring to FIG. 3, the air conditioner 20 according to an embodiment may be communicatively connected to the server 10, and may transmit unique information of the outdoor units 21 and unique information of the indoor units 22 to the server 10 (510).

The user terminal 30 may transmit location information of the user terminal 30 during a test operation (520). For example, the user terminal 30 may transmit the location information to the server 10 while simultaneously transmitting a test operation command to the air conditioner 20. In addition, when transmitting the test operation command to the server 10, the user terminal 30 may receive a location information transmission command from the server 10 and transmit the location information.

The server 10 may generate first location information indicating the respective locations of the plurality of outdoor units (530), based on the received unique information of the plurality of outdoor units and the received unique information of the plurality of indoor units of the air conditioner 20 and the location information where the user terminal 30 was located during the test operation of the air conditioner 20. The above information may be stored in the storage 130 of the server 10.

In a case where unique information of the air conditioner 20 is input from a user, the user terminal 30 may transmit the input information to the server 10 (540). In a case where information for identifying one of the plurality of outdoor units is received from the user terminal 30, the server 10 may request the user terminal 30 to transmit second location information which is current location information of the user terminal 30 (550).

In a case where the user terminal 30 receives the request for transmitting the second location information from the server 10, the user terminal 30 may transmit the second location information to the server 10 (560). However, transmitting the second location information is not limited thereto, and the user terminal 30 may transmit the second location information when transmitting the input information to the server 10.

The server 10 may determine whether to operate a fan of the outdoor unit 21 using the second location information and the first location information corresponding to the user input (570). For example, in a case where a distance between the user terminal 30 and one of the plurality of outdoor units is within a preset distance, the server 10 may allow all of the indoor units 22 connected to the outdoor unit 21 to be turned on and to be turned off after a defined period of time.

In addition, the server 10 may transmit the determined control command to the air conditioner 20 (580).

The air conditioner 20 may control the indoor unit 22 or the outdoor unit 21 based on the control command transmitted from the server 10 (590).

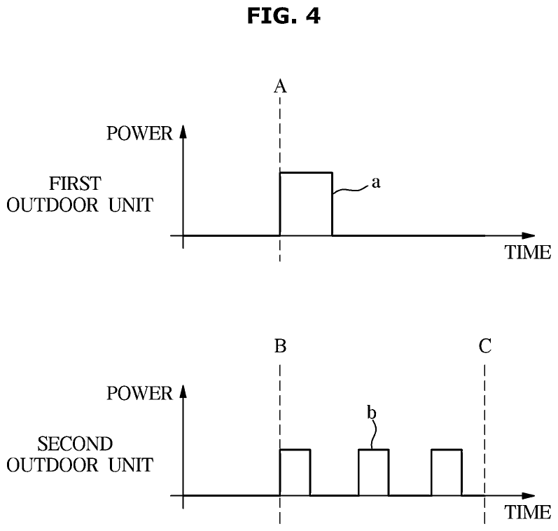

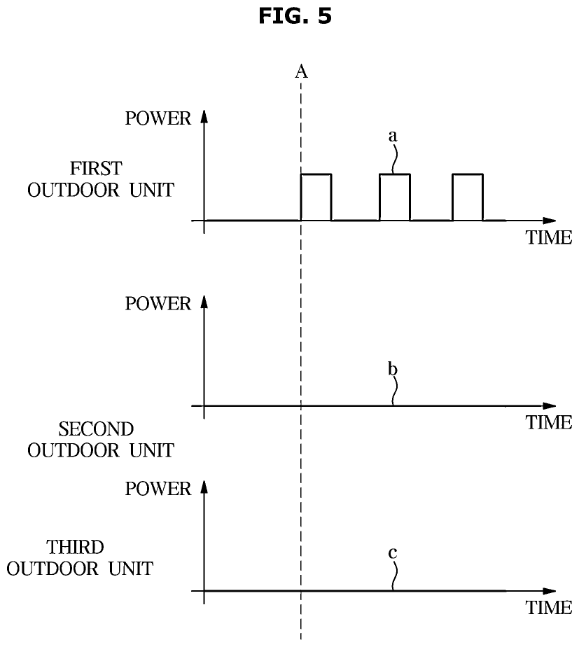

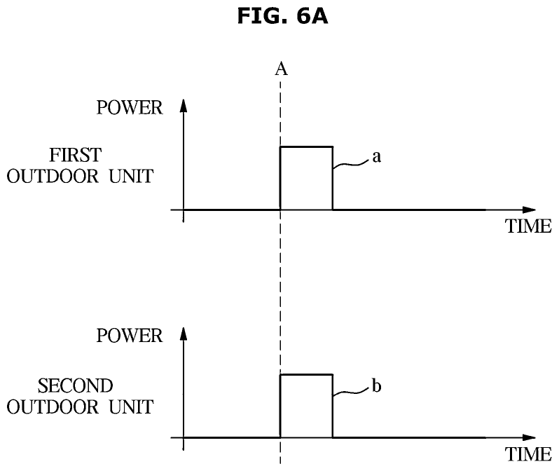

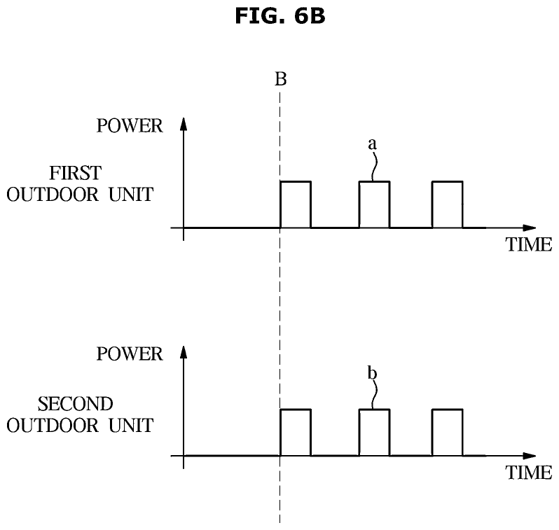

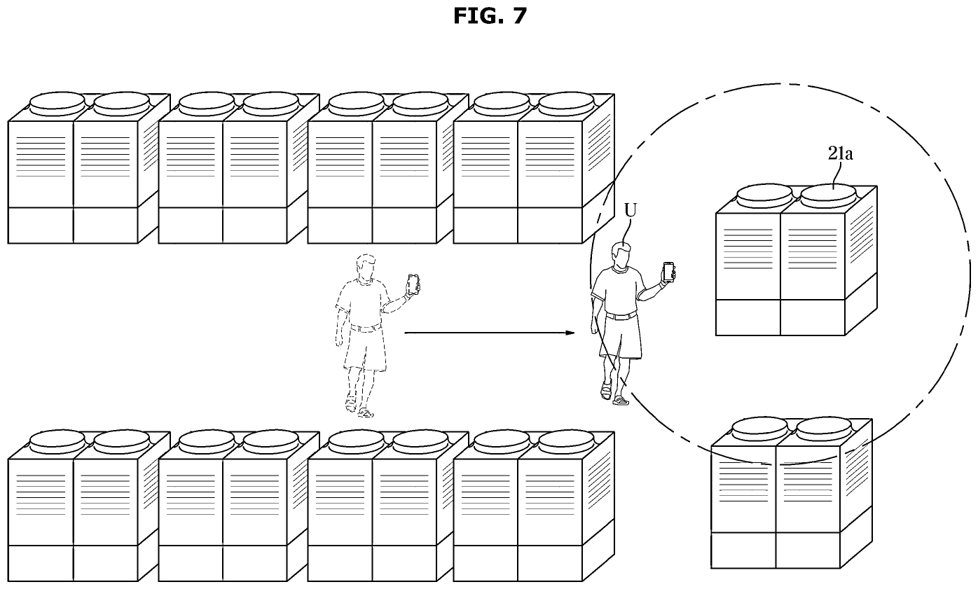

FIG. 4 and FIG. 5 are diagrams illustrating an operation of an outdoor unit according to an embodiment of the disclosure. FIG. 6A and FIG. 6B are diagrams illustrating an operation of an indoor unit according to an embodiment of the disclosure. FIG. 7 is a view illustrating an operation of an air conditioner according to an embodiment of the disclosure.

Referring to FIG. 4, FIG. 5, FIG. 6A and FIG. 6B, a method of controlling an outdoor unit or an indoor unit by the air conditioner 20 based on a control command transmitted from the server 10 is described.

Referring to FIG. 4, FIG. 4 is a diagram showing a power signal waveform of the outdoor unit according to a distance between the user terminal 30 and the outdoor unit.

Referring to “a” of FIG. 4, in a case where a distance between the user terminal 30 and a first outdoor unit is within a preset distance (after a point “A” of FIG. 4), the air conditioner 20 may receive a control command from the server 10 and control a plurality of indoor units connected to the first outdoor unit to allow the first outdoor unit to be turned on and to be turned off after a defined period of time.

In addition, referring to “b” of FIG. 4, in a case where the distance between the user terminal 30 and the first outdoor unit is within the preset distance (after a point “B” of FIG. 4), the air conditioner 20 may receive a control command from the server 10 and control the plurality of indoor units connected to the first outdoor unit to allow the first outdoor unit to be periodically turned on and to be turned off after a defined period of time. In addition, in a case where the distance between the user terminal 30 and the first outdoor unit is outside the preset distance (after a point “C” of FIG. 4), the air conditioner 20 may receive a control command from the server 10 and control the plurality of indoor units connected to the first outdoor unit to allow the first outdoor unit to be turned off. Through the above, a user may find the outdoor unit by following an operation sound of the outdoor unit fan.

Referring to FIG. 5, “a” of FIG. 5 is a graph showing an operation of the first outdoor unit whose unique information is input from a user, and “b” and “c” of FIG. 5 are graphs showing an operation of a second outdoor unit and a third outdoor unit whose unique information is not input from the user.

Referring to “a” of FIG. 5, in a case where the distance between the user terminal 30 and the first outdoor unit is within the preset distance (after a point “A” of FIG. 5), the plurality of indoor units connected to the first outdoor unit may be controlled to allow the first outdoor unit to be periodically turned on and to be turned off after a defined period of time.

Referring to “b” and “c” of FIG. 5, in a case where a distance between the user terminal 30 and the second outdoor unit and the third outdoor unit whose unique information is not input from the user is within the preset distance (after a point “b” and a point “c” of FIG. 5), operation of the second outdoor unit and the third outdoor unit does not change. Through the above, the user may find the outdoor unit corresponding to the input unique information.

Referring to FIG. 6A, FIG. 6A is a diagram showing a power signal waveform of a first indoor unit and a second indoor unit connected to a first outdoor unit according to a distance between the user terminal 30 and the first outdoor unit.

Referring to FIG. 6A, in a case where the distance between the user terminal 30 and the first outdoor unit is within a preset distance (after a point “A” of FIG. 6A), the air conditioner 20 may receive a control command from the server 10 and control both the first indoor unit and the second indoor unit connected to the first outdoor unit to be turned on and to be turned off after a defined period of time.

In addition, referring to FIG. 6B, in a case where the distance between the user terminal 30 and the first outdoor unit is within the preset distance (after a point “B” of FIG. 6B), the air conditioner 20 may receive a control command from the server 10 and control both the first indoor unit and the second indoor unit connected to the first outdoor unit to be periodically turned on and to be turned off after a defined period of time.

Referring to FIG. 7, when a user U carrying the user terminal 30 approaches a first outdoor unit 21a and a distance between the user terminal 30 and the first outdoor unit 21a is a preset distance, the first outdoor unit 21a or an indoor unit connected to the first outdoor unit 21a is turned on and turned off after a defined period of time, and thus a fan of the first outdoor unit 21a may operate. The user U may find the location of the outdoor unit 21a more quickly by using an operation sound of the fan of the outdoor unit 21a.

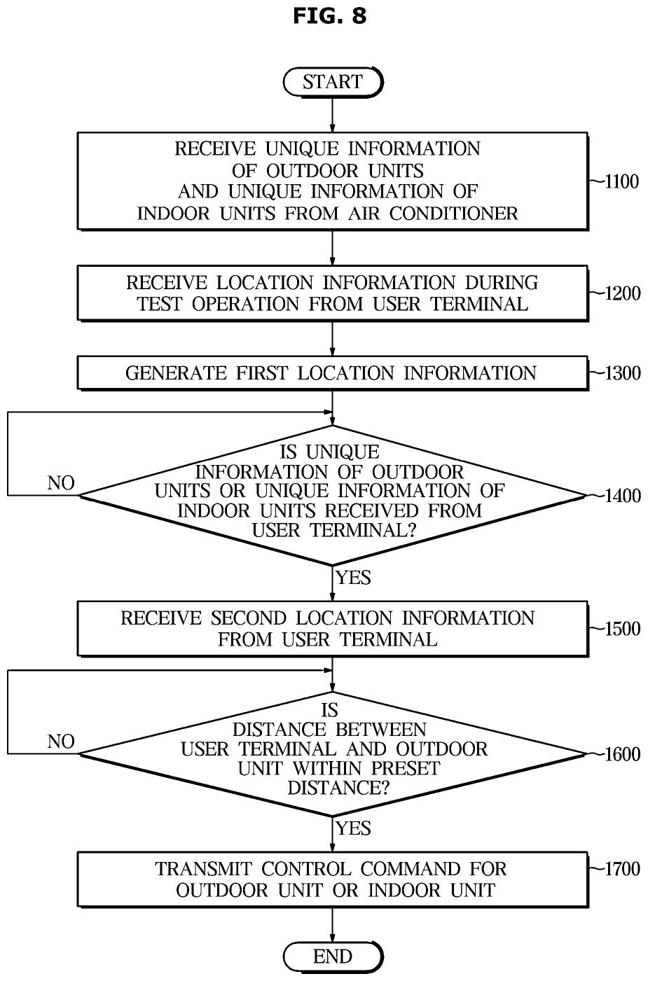

FIG. 8 is a flowchart illustrating a case in which a server of an air conditioning system transmits a control command for controlling an air conditioner according to an embodiment of the disclosure.

Referring to FIG. 8, the server 10 may receive unique information of the outdoor units 21 and unique information of the indoor units 22 from the air conditioner 20 communicatively connected to the server (1100).

The server 10 may store the received unique information of the plurality of outdoor units and unique information of the plurality of indoor units in the storage.

The server 10 may receive location information of the user terminal 30 during a test operation of the air conditioner 20 and store the location information of the user terminal during the test operation in the storage (1200).

Accordingly, the server 10 may generate and store connection information of the plurality of outdoor units and the plurality of indoor units and first location information indicating the respective locations of the plurality of outdoor units (1300).

The server 10 may receive the unique information of the outdoor units 21 or the unique information of the indoor units 22 from the user terminal 30 (Yes in operation 1400).

When receiving the unique information of the air conditioner 20 from the user terminal 30, the server 10 may request the user terminal 30 to transmit second location information which is current location information of the user terminal 30 (1500).

The server 10 may determine the first location information corresponding to a user input. For example, in a case where a serial number of the indoor unit 22 is input by the user, the server 10 may determine the outdoor unit 21 connected to the indoor unit 22 and the first location information of the outdoor unit 21.

The server 10 may determine whether a distance between the user terminal 30 and the determined outdoor unit 21 is within a preset distance by using the determined first location information and the received second location information (1600).

In a case where the distance between the user terminal 30 and the determined outdoor unit 21 is within the preset distance (Yes in operation 1600), the server 10 may transmit a control command for controlling the outdoor unit 21 or the indoor unit 22 to the air conditioner 20 (1700). For example, the air conditioner 20 may control all of the indoor units connected to the determined outdoor unit 21 to be turned on and to be turned off after a defined period of time.

Meanwhile, the disclosed embodiments may be implemented in the form of a recording medium storing instructions executable by a computer. The instructions may be stored in the form of program code and, when executed by a processor, may generate a program module to perform the operations of the disclosed embodiments. The recording medium may be implemented as a computer-readable recording medium.

The computer-readable recording medium may include all kinds of recording media storing instructions that may be interpreted by a computer. For example, the computer-readable recording medium may be a Read Only Memory (ROM), a Random Access Memory (RAM), a magnetic tape, a magnetic disk, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. An air conditioning system, comprising:
an air conditioner comprising a plurality of outdoor units and a plurality of indoor units communicatively connected to each other; and
a server configured to be communicatively connected to the air conditioner, so that while the server is communicatively connected to the air conditioner, the air conditioner is configured to transmit unique information of the plurality of outdoor units and unique information of the plurality of indoor units to the server, and
wherein the server is configured to:
generate first location information indicating locations of the plurality of outdoor units based on the unique information of the plurality of outdoor units, the unique information of the plurality of indoor units, and location information of a user terminal during a test operation of the plurality of outdoor units and the plurality of indoor units, and
transmit a control command to control the air conditioner using the first location information and second location information that indicates a current location of the user terminal to the air conditioner, based on unique information of the at least one outdoor unit among the plurality of outdoor units or unique information of at least one indoor unit among the plurality of indoor units being input from a user.

2. The air conditioning system of claim 1, wherein the server is configured to determine a distance between the user terminal and the at least one outdoor unit among the plurality of outdoor units based on the first location information and the second location information, and
based on the distance between the user terminal and the at least one outdoor unit among the plurality of outdoor units being within a preset distance, transmit, to the air conditioner, a control command to control the plurality of indoor units connected to the at least one outdoor unit among the plurality of outdoor units to allow the at least one outdoor unit among the plurality of outdoor units to be turned on and to be turned off after a defined period of time.

3. The air conditioning system of claim 1, wherein the server is configured to determine a distance between the user terminal and the at least one outdoor unit among the plurality of outdoor units based on the first location information and the second location information, and
based on the distance between the user terminal and the at least one outdoor unit among the plurality of outdoor units being within a preset distance, transmit, to the air conditioner, a control command to control the plurality of indoor units connected to the at least one outdoor unit among the plurality of outdoor units to allow the at least one outdoor unit among the plurality of outdoor units to be turned on and off periodically.

4. The air conditioning system of claim 1, wherein the server is configured to determine a distance between the user terminal and the at least one outdoor unit among the plurality of outdoor units based on the first location information and the second location information, and
based on the distance between the user terminal and the at least one outdoor unit among the plurality of outdoor units being within a preset distance, transmit, to the air conditioner, a control command to allow all of the plurality of indoor units connected to the at least one outdoor unit among the plurality of outdoor units to be turned on and to be turned off after a defined period of time.

5. The air conditioning system of claim 1, wherein the server is configured to determine a distance between the user terminal and the at least one outdoor unit among the plurality of outdoor units based on the first location information and the second location information, and
based on the distance between the user terminal and the at least one outdoor unit among the plurality of outdoor units being within a preset distance, transmit, to the air conditioner, a control command to allow all of the plurality of indoor units connected to the at least one outdoor unit among the plurality of outdoor units to be turned on and off periodically.

6. The air conditioning system of claim 1, wherein the unique information of the plurality of outdoor units or the unique information of the plurality of indoor units includes at least one of device information of the plurality of outdoor units, serial numbers of the plurality of outdoor units, device information of the plurality of indoor units, serial numbers of the plurality of indoor units, or information input by the user during the test operation.

7. The air conditioning system of claim 1, wherein the server is configured to transmit, to the user terminal, a control command to allow the user terminal to output a screen displaying the first location information, based on the unique information of the at least one outdoor unit among the plurality of outdoor units or the unique information of the at least one indoor unit among the plurality of indoor units being input from the user.

8. A method of controlling an air conditioning system, the method comprising:
transmitting, by an air conditioner of the air conditioning system, unique information of a plurality of outdoor units and unique information of a plurality of indoor units to a server communicatively connected to the air conditioner, the plurality of outdoor units and the plurality of indoor units being communicatively connected to each other;
generating, by the server, first location information indicating locations of the plurality of outdoor units based on the unique information of the plurality of outdoor units, the unique information of the plurality of indoor units, and location information of a user terminal during a test operation of the plurality of outdoor units and the plurality of indoor units; and
transmitting, by the server, a control command to control the air conditioner using the first location information and second location information that indicates a current location of the user terminal to the air conditioner, based on unique information of the at least one outdoor unit among the plurality of outdoor units or unique information of at least one indoor unit among the plurality of indoor units being input from a user.

9. The method of claim 8, wherein the transmitting of the control command to the air conditioner determines a distance between the user terminal and the at least one outdoor unit among the plurality of outdoor units based on the first location information and the second location information, and
based on the distance between the user terminal and the at least one outdoor unit among the plurality of outdoor units being within a preset distance, transmits, to the air conditioner, a control command for controlling the plurality of indoor units connected to the at least one outdoor unit among the plurality of outdoor units to allow the at least one outdoor unit among the plurality of outdoor units to be turned on and to be turned off after a defined period of time.

10. The method of claim 8, wherein the transmitting of the control command to the air conditioner determines a distance between the user terminal and the at least one outdoor unit among the plurality of outdoor units based on the first location information and the second location information, and
based on the distance between the user terminal and the at least one outdoor unit among the plurality of outdoor units being within a preset distance, transmits, to the air conditioner, a control command for controlling the plurality of indoor units connected to the at least one outdoor unit among the plurality of outdoor units to allow the at least one outdoor unit among the plurality of outdoor units to be turned on and off periodically.

11. The method of claim 8, wherein the transmitting of the control command to the air conditioner determines a distance between the user terminal and the at least one outdoor unit among the plurality of outdoor units based on the first location information and the second location information, and
based on the distance between the user terminal and the at least one outdoor unit among the plurality of outdoor units being within a preset distance, transmits, to the air conditioner, a control command to allow all of the plurality of indoor units connected to the at least one outdoor unit among the plurality of outdoor units to be turned on and to be turned off after a defined period of time.

12. The method of claim 8, wherein the transmitting of the control command to the air conditioner determines a distance between the user terminal and the at least one outdoor unit among the plurality of outdoor units based on the first location information and the second location information, and
based on the distance between the user terminal and the at least one outdoor unit among the plurality of outdoor units being within a preset distance, transmits, to the air conditioner, a control command to allow all of the plurality of indoor units connected to the at least one outdoor unit among the plurality of outdoor units to be turned on and off periodically.

13. The method of claim 8, wherein the unique information of the plurality of outdoor units or the unique information of the plurality of indoor units includes at least one of device information of the plurality of outdoor units, serial numbers of the plurality of outdoor units, device information of the plurality of indoor units, serial numbers of the plurality of indoor units, or information input by the user during the test operation.

14. The method of claim 8, wherein the server is configured to transmit, to the user terminal, a control command to allow the user terminal to output a screen displaying the first location information, based on the unique information of the at least one outdoor unit among the plurality of outdoor units or the unique information of the at least one indoor unit the plurality of indoor units being input from the user.
